(19) United States
(12) Patent Application Publication
(10) Pub. No.: US 2026/0226864 A1
(43) Pub. Date: Aug. 6, 2026

(54) UTILIZING A COMBINED EMPIRICAL AND DETERMINISTIC MODEL FOR AUTOMATED TUNING OF GAS TURBINE COMBUSTION SYSTEMS

(71) Applicant: NAES Corporation, Issaquah, WA (US)

(72) Inventors: James Michael Nichols, Denver, CO (US); Christopher Nelson Chandler, Austin, TX (US); Robert Alaric Scott, Severance, CO (US)

(21) Appl. No.: 19/465,469

(22) Filed: Jan. 30, 2026

Related U.S. Application Data
(60) Provisional application No. 63/752,453, filed on Jan. 31, 2025.

(51) Int. Cl. F02C 9/00; F02C 6/18

(52) U.S. Cl. CPC F02C 9/00; F02C 6/18; F05D 2270/20

(57) ABSTRACT

Methods and systems are provided for automated tuning of gas turbines and other combustion systems. In certain examples, a gas turbine combustion system may include a tuning controller including non-transitory memory and executable instructions, stored in the non-transitory memory, that, if executed by a processor, cause the tuning controller to: receive one or more operational parameters; and cause one or more operational control elements, that are to control one or more actuatable components of the gas turbine combustion system, to be proportionally adjusted based at least in part, on a magnitude of an error of the one or more operational parameters relative to a threshold.

### CROSS-REFERENCE TO RELATED APPLICATION

The present application claims priority U.S. Provisional Application No. 63/752,453, entitled “UTILIZING A COMBINED EMPIRICAL AND DETERMINISTIC MODEL FOR AUTOMATED TUNING OF GAS TURBINE COMBUSTION SYSTEMS” and filed on Jan. 31, 2025. The entire contents of the above-identified application are hereby incorporated by reference for all purposes.

### BACKGROUND

Selecting appropriate magnitudes of tuning parameters for gas turbine combustion systems, and timing for their implementation, can be complex. Methods and systems for tuning such gas turbine combustion systems that account for such complexities are desirable.

### BRIEF DESCRIPTION OF THE DRAWINGS

It should be understood that the present disclosure is not limited to the precise arrangements and instrumentalities shown in the drawings.

FIG. 1 shows an example embodiment of the communications topology of an operational plant encompassing a gas turbine system and incorporating an autotuning controller;

FIG. 2 shows an example embodiment for the determination of system stability utilized by the autotuner;

FIG. 3 shows an example embodiment of a functional flow chart for the determination of High NOx Error and Low NOx Error Adjustments to Fuel Split1 according to the present disclosure;

FIG. 4 shows an example embodiment of a functional flow chart for the determination of the Total Adjustment to Fuel Split1 according to the present disclosure;

FIG. 5 shows a first example of the autotuning system manipulating an operational control element of the gas turbine as contemplated within the present disclosure;

FIG. 6 shows a second example of the autotuning system manipulating an operational control element of the gas turbine as contemplated within the present disclosure;

FIG. 7 shows a third example of the autotuning system manipulating an operational control element of the gas turbine as contemplated within the present disclosure;

FIG. 8 shows a fourth example of the autotuning system manipulating an operational control element of the gas turbine as contemplated within the present disclosure; and

FIG. 9 shows an example embodiment of a flow chart for automatically adjusting operation of a gas turbine.

### DETAILED DESCRIPTION

Techniques described and suggested herein include at least one embodiment of an automated system that senses the operation of a gas turbine engine and facilitates optimal or improved combustor and turbine performance through the use of adjustments of operating parameters via novel empirical and deterministic methods.

In at least one embodiment, a computer-implemented method, for automatically adjusting operation of a gas turbine, includes: receiving, at a tuning controller, one or more operational parameters that are to indicate measured values of the gas turbine (e.g., associated with exhaust emissions and/or combustor dynamics); inferring, by the tuning controller, whether the gas turbine is in a stable operating condition (e.g., based, at least in part, on one or more tuning constants f the gas turbine); and responsive to either the gas turbine being inferred to be in the stable operating condition or a bypass condition being met, using the tuning controller to: calculate an error, for each operational parameter of the one or more operational parameters that meets a corresponding threshold of one or more thresholds, based, at least in part, on a magnitude of the operational parameter relative to the corresponding threshold; and proportionally adjust one or more operational control elements (such as one or more of combustor fuel flow distribution reference, fuel gas inlet temperature, fuel gas inlet fuel composition, turbine exhaust temperature reference, or combustor bypass valve position), that are to control one or more actuatable components of the gas turbine, based, at least in part, on the calculated error.

In at least one embodiment, a gas turbine combustion system includes: a combustion engine including a plurality of actuatable components; one or more sensors that are to measure one or more operating conditions of the combustion engine; and a tuning controller including non-transitory memory and executable instructions, stored in the non-transitory memory, that, if executed by one or more processors of the tuning controller, cause the tuning controller to: receive, from the one or more sensors, a plurality of input parameters including exhaust emissions levels, combustor dynamics, exhaust temperatures, compressor inlet and outlet temperatures and pressures, heat recovery steam generator (HRSG) critical system parameters, and/or fuel system parameters; retrieve a plurality of thresholds to which the plurality of input parameters are to be respectively compared; and cause one or more operational control parameters (such as one or more of combustor fuel flow distribution reference, fuel gas inlet temperature, fuel gas inlet fuel composition, turbine exhaust temperature reference, or combustor bypass valve position), that are to control at least a portion of the plurality of actuatable components, to be proportionally adjusted based, at least in part, on an amount of deviation of an input parameter of the plurality of input parameters from a respective threshold of the plurality of thresholds

In at least one embodiment, a non-transitory computer-readable storage medium stores computer-executable instructions that, if executed by one or more processors of a computing system, are to cause the computing system to: receive, as input, measurements of one or more operational parameters of a combustion system from one or more sensors, the one or more operational parameters corresponding to one or more of combustor fuel flow distribution, turbine exhaust temperature, turbine exhaust emissions, or combustor dynamics; and proportionally adjust one or more operational control elements, that are to cause one or more engine components of the combustion system to be actuated, based, at least in part, on a magnitude of error of the measurements relative to a threshold value, the one or more operational control elements including one or more of combustor fuel flow distribution reference, fuel gas inlet temperature, fuel gas inlet fuel composition, turbine exhaust temperature reference, or combustor bypass valve position.

Reduction of gas turbine exhaust NOx emissions may be desirable, with efforts primarily focused on localized attenuation of a gas turbine combustor flame front's hot spots (e.g., areas of localized excessive fuel-air ratio). Some technology centers around injecting water or steam at or near the fuel nozzles-this may be referred to in certain examples as “standard” combustion with steam/water NOx abatement. While effective, these standard combustors tend to have a high cost of operation due to their use of high quality water or steam consumption. Plant economics continue to drive the power generation industry toward cheaper methods of NOx reduction.

Lean premixed combustion systems premix the fuel and air prior to burning and utilize the nitrogen in air as a moderator in the combustion process, drawing localized energy out of the flame front chemical reaction. As localized hot sections of the combustor are diffused, the dominant mechanism for NOx generation is also reduced. This technology is much cheaper than water or steam injection; however, there are tradeoffs-the combustion process is much less stable for lean premixed combustors than their “standard” counterparts.

In a sense, the inert nitrogen molecules are agnostic-they make hot zones (localized areas of rigorous flames within a combustor) and cold zones (weak flame zones) colder, or weaker. While making these hot zones weaker is generally considered good (from the perspective of NOx reduction), further weakening of the cold zones can lead a combustion system toward excessive CO emissions and/or blowout-blowout may result in a gas turbine tripping off-line in certain examples.

While excessive emissions production is a leading technical constraint of both standard and lean premixed combustion systems, another operational aspect of gas turbine combustion is excessive combustor dynamics. Any combustion process is unstable, and this instability manifests itself as pressure oscillations within the combustion chamber(s). These pressure oscillations cause the physical hardware to move and vibrate, causing excessive component wear, and, in extreme cases, mechanical failure. While premixing the fuel and air prior to combustion lowers the NOx emissions, lean premixed combustors have much higher propensity to cause excessive combustor dynamics than their diffusion flame, or standard combustor, counterparts.

Therefore, while lean premixed combustion systems are an effective way to reduce nitrous oxide or NOx emissions, continual management may be implemented to ensure performance of such systems. This management of the combustion process can be achieved through changes in the fuel composition or inlet temperature, geometric redistribution of the fuel flow within the combustor, and/or changes to the combustor (and perhaps the turbine) overall fuel-air (fuel-to-air) ratio—this process is referred to as “tuning” in certain examples.

Certain embodiments are focused on a static approach toward tuning, whereby an experienced combustion tuner (e.g., a human operator) may manually adjust a series of control parameters dictating fuel distribution and/or turbine operation. If done well, this manual approach could last for a period of months; but it could become less effective as ambient conditions or operational conditions deviate from those experienced during the manual tune. One example standard: lean premixed combustion systems manually tuned twice a year.

Though manual tuning can be optimized, the as-left settings can be a compromise of current operation with the expected ambient conditions the unit may experience over the next 4-6 months. As an alternative, in certain examples, a computerized algorithm may continuously (e.g., responsively) tune a gas turbine combustor for its current ambient conditions and operational state (also referred to herein as “autotuning”).

Autotuners can generally be characterized into 2 types: deterministic and empirical. Deterministic autotuners are generally referred to as model-based systems—exhaust emissions, combustor stability parameters, and turbine operating parameters are often calculated, with changes made to the turbine controller to achieve calculated optimal performance (e.g., as defined by the model). While model-based control systems are able to quickly adjust a turbine's operation, they are only as good as the models themselves—if a model's prediction deviates from actual observed conditions, or if a model's solution degrades over time, turbine operation can be adversely affected. Additionally, model-based systems often require a significant amount of up-front, or commissioning, time and effort to get the models set up correctly (not to mention the fact that the models can subsequently degrade as time goes on).

Empirical autotuners tend to rely much more on a machine's sensor outputs than a model-based system. For instance, a model-based solution may not agree with the gas turbine's NOx measurement and may instead calculate the gas turbine exhaust NOx, whereas an empirical autotuner may solely rely on the measured NOx emissions as input. Empirical autotuners often have strict operational structure (or architecture) that is adhered to when tuning. For example, certain empirical systems adjust a turbine's control parameters in fixed increments, in fixed amounts of time, toward upper or lower boundary limits if tuning is deemed necessary.

In certain examples, empirical autotuners may result in better performance than deterministic autotuners. However, significant limitations can occur with empirical autotuners.

Empirical autotuners often tend to automate a manual tuning process—they adjust operational control parameters (e.g., fuel gas inlet conditions, fuel splits, turbine or combustor fuel-to-air ratio, etc.) a fixed, incremental amount, wait, and then proceed to determine or otherwise infer if another adjustment is needed. In certain examples, empirical autotuners may only tune for one operational constraint, or tuning issue, at a time, which is typically a subset of either excessive emissions or combustor dynamics.

In one embodiment, this operational constraint is referred to as the “dominant tuning theme.” Similarly, another embodiment refers to this same operational constraint as the “first out-of-tune parameter.” Such approaches determine or otherwise infer a series of operational constraints (e.g., emissions, combustor dynamics, etc.) that are above tuning thresholds (creating tuning issues), rank them, and tune for the tuning issue (or anomaly) that is deemed most significant (e.g., based on the ranking). In mitigating this most significant tuning issue, these approaches make fixed, incremental adjustments at fixed time increments until the dominant tuning theme or first out-of-tune parameter is resolved.

Embodiments of a system that uses real-time data for operational parameters but does not follow a fixed, incremental tuning adjustment approach based on a single most-significant tuning anomaly are contemplated. These, as well as other aspects, advantages, and alternatives will become apparent to those of ordinary skill in the art by reading the following detailed description, with reference where appropriate to the accompanying drawings. Further, it should be understood that descriptions and figures provided herein are intended to illustrate the invention by way of example only and, as such, that numerous variations are possible.

For example, the following description relates to various embodiments of a tuning controller and a method for tuning the operation of a gas turbine, or a gas/combustion turbine, that has sensors to measure operational parameters of the turbine and controls (e.g., actuatable elements) to adjust operational control elements, or operational control parameters, of the turbine. In at least one embodiment, the operational parameters of the turbine, which are received by the tuning controller, include one or more of the following: combustor fuel flow distribution, turbine exhaust temperature (a surrogate for both combustor and turbine overall fuel-air ratio), turbine exhaust emissions, or combustor dynamics. In at least one embodiment, the operational control elements of the turbine include one or more of the following: combustor fuel flow distribution reference, fuel gas inlet temperature or fuel composition, turbine exhaust temperature reference (turbine overall fuel-air ratio), or combustor bypass valve position (combustor fuel-air ratio). In certain examples, the tuning controller has communications with the (separate) turbine controller. In additional or alternative examples, the tuning controller can have communications with various other systems to receive input parameters, such as exhaust emissions, combustor dynamics, and/or heat recovery steam generator (HRSG) critical system parameters.

In at least one embodiment, the tuning controller first receives measurements or other data, such as turbine exhaust emissions and/or combustor dynamics, from the sensors. These data are comparable to desired levels or limits, which may be set (e.g., preset or otherwise defined by an operator or other user) and stored within non-transitory memory of the tuning controller. In certain examples, if sensor data is above a high level limit, or below a low level limit, the degree of deviation away from the respective limit may be calculated, and may be referred to as “error”—this error is what the tuning controller attempts to mitigate through changes to the operational control elements.

Emissions Error may include one or more of High NOx, Low NOx, or High CO, for example. In certain examples, broadband dynamics data is processed into specific frequency ranges of interest for combustion tuning, and Dynamics Error may include one or more of High or Low Class0, Class1, Class2, or Class3 Dynamics. It is contemplated that High and Low Limits for any particular tuning concern (e.g., NOx, Class0 Dynamics, etc.) are not the same—the tuning controller does not tune toward a target value, but rather to ensure that a particular operational parameter continually lies within a range specified between high and/or low limits.

The possibility exists to modify the size of the change to an operational control element proportional to the magnitude of the error in either a linear or non-linear fashion. The concept of logical states specifying multiple levels of tuning issues (e.g., High Class2 Dynamics vs. High-High Class2 Dynamics, High NOx vs. High-High NOx, etc.), or a Boolean logic-based tuning issue hierarchy, is not utilized in certain embodiments.

Certain embodiments of the tuning controller described herein are largely empirical in nature. For example, it calculates in real-time all associated (that is, current and detectable) tuning anomalies and provides adjustments to the turbine's operational control elements via an aggregated response to all current anomalies. In one embodiment, if the system is adjusting parameters for one tuning concern (e.g., High Class1 Dynamics), and another tuning concern arises (e.g., High NOx) during this process, the tuning controller can adjust its response to tune for both tuning issues simultaneously, regardless if specific modifications to the operational control elements are contradictory in magnitude for each respective tuning issue alone.

In at least one embodiment, the tuning controller may modify more than one operational control element simultaneously in response to one or more disparate tuning issues.

In at least one embodiment, a combination of disparate tuning concerns can be incorporated into a singular multi-variable dependent response to an operational control element. For instance, if the tuning issues Low NOx and High Class2 Dynamics exist simultaneously, the combination of the two Errors (Low NOx Error and High Class2 Dynamics Error), can drive a specific response in the operational control element FuelSplit1. This FuelSplit1 response can vary with the extent of the Low NOx Error and the High Class2 Dynamics Error.

The present disclosure relates to systems and methods utilized in the automated tuning of combustion systems, such as for gas turbines used for power generation. However, the teachings provided herein can be extended or adapted to other types of combustion turbines. Thus, the terms used are not intended to limit the embodiments described herein. Rather, it is understood that the embodiments described herein are extendible to other systems, methods, and computer readable media used for automated tuning of combustion turbines within the general field of combustion, or gas, turbines.

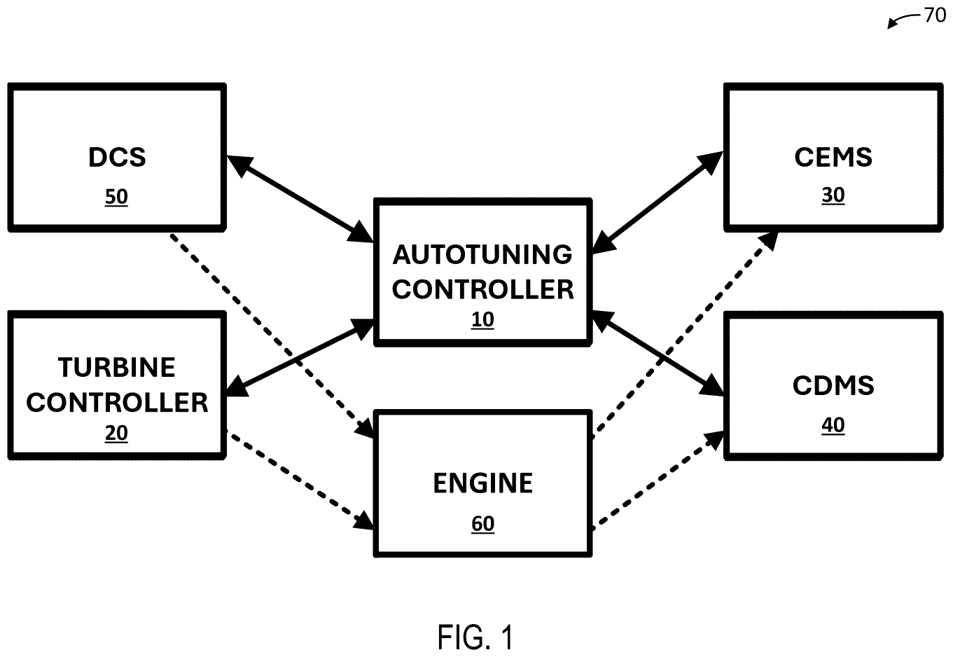

FIG. 1 shows an example communications topology 70 for a gas turbine engine 60, with ancillary equipment, that incorporates an autotuning controller, or autotuner, 10. The autotuning controller 10 communicates directly with the turbine controller 20, continuous emissions monitoring system (CEMS) 30, continuous dynamics monitoring system (CDMS) 40, and the plant distributed control system (DCS) 50. It is understood that this is an example embodiment, and that other configurations may have different topologies—some systems may not have a DCS 50 nor/or a CDMS 40, for instance. Additionally, some example systems may have the emissions information passed to the autotuning controller 10 from the turbine controller 20 or the DCS 50. Communication pathways are shown in FIG. 1 as bi-directional, meaning the autotuning controller 10 can read/write from/to other devices as needed, e.g., within a Master-Slave protocol or a Client-Server protocol.

The relevant operational data is received from one or more sensors, such as from one or more of the components shown in FIG. 1. For example, the combustor pressure oscillation (or dynamics) data may originate with dynamic pressure sensors provided by the CDMS 40. It should be noted that the combustor dynamics sensors can also, or alternatively, be configured to send their data directly to the turbine controller 20 (this communication pathway is not shown in FIG. 1), which may then communicate this information to the autotuning controller 10. Emissions data is obtained via species measuring sensors associated with the CEMS 30 in certain embodiments. Various parameters associated with a Heat Recovery Steam Generator (HRSG) and/or a Fuel Gas Temperature Controller are sent to the autotuning controller 10 via a DCS 50 in certain embodiments. In at least one embodiment, the Fuel Gas Temperature Controller controls the Fuel Gas Inlet Temperature to the gas turbine. In at least one embodiment, the turbine controller 20 houses the gas turbine controls, and provides the sensor data associated with turbine operation—this information can include (but is not limited to) exhaust temperatures, compressor inlet and outlet temperatures and pressures, and fuel system parameters. In certain embodiments, the turbine controller 20 also provides the autotuner 10 with the relevant control constants associated with the operational control elements that the autotuner 10 is to adjust.

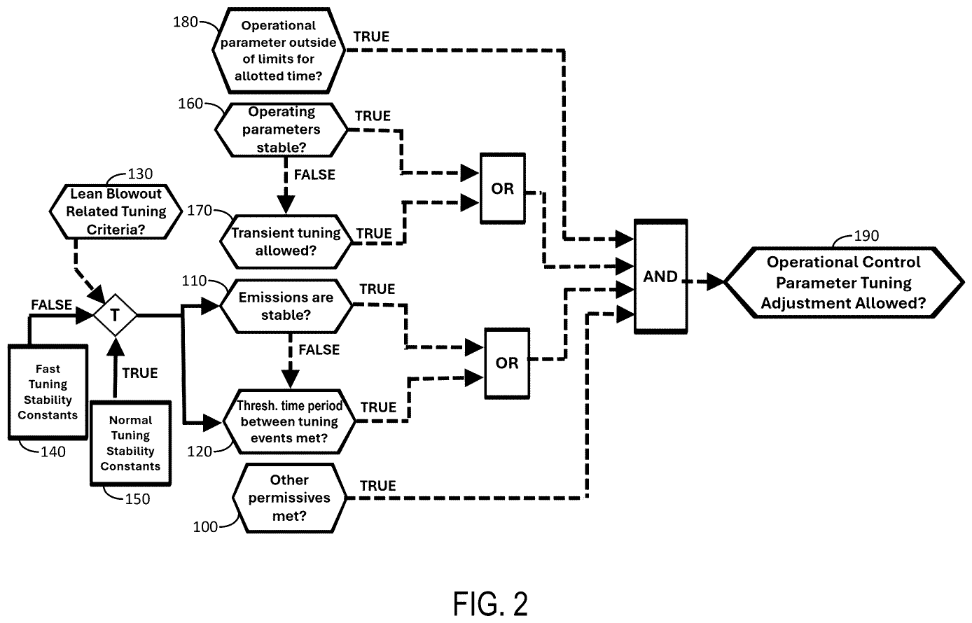

In an example embodiment, relevant operational information may be collected by the autotuner 10 several times per minute—this data is considered to be real-time in nature, with the possible exception that emissions data may be time-lagged by 2-4 minutes due to sampling line capacity constraints (the point of measurement for emissions may be, for example, 100+ feet away from the respective analyzers). It is this emissions-based time lag that may benefit from the autotuner 10 incorporating a time-lag approach to be used in its adjustment algorithms. One such approach is shown in FIG. 2 below.

In an example embodiment, the autotuner 10, the turbine controller 20, the CEMS 30, the CDMS 40, and the DCS 50 may be implemented as a set of controllers communicably coupled via a network, including non-transitory memory on which executable instructions may be stored. The executable instructions may be executed by one or more processors of the set of controllers to perform various functionalities of the gas turbine engine 60. Accordingly, the executable instructions may include various routines for operation, maintenance, and testing of the gas turbine engine 60 under various operating conditions. The set of controllers may further include a user interface at which an operator of the gas turbine engine 60 may enter commands or otherwise modify operation of the gas turbine engine 60. The user interface may include various components for facilitating operator use of the gas turbine engine 60 and for receiving operator inputs (e.g., requests to generate power, etc.), such as one or more displays, input devices (e.g., keyboards, touchscreens, computer mice, depressible buttons, mechanical switches, other mechanical actuators, etc.), lights, etc. The set of controllers may be communicably coupled to various components of the gas turbine engine 60 to command actuation and use thereof.

FIG. 2 shows a functional flow chart for the determination of system stability, for an autotuner, such as the autotuner 10 of FIG. 1, to make adjustments to an operational control parameter. In at least one embodiment, numbered elements depicted in FIG. 2 are represented, in the autotuner, as executable code stored in non-transitory memory that, if performed by one or more processors, cause the one or more processors to perform the operations described herein. For example, element 110 identifies one or more Emissions Stability Criteria for the emissions measurement that are to be met before the autotuner can make an adjustment. In at least one embodiment, this can be overridden by element 120, which identifies if a sufficiently long period of time, e.g., well beyond the time lag of the CEMS 30, is met. In other embodiments, the Emissions Stability Criteria are confirmed to be met before proceeding to element 190 regardless of whether element 120 has been satisfied. The time constants and operational parameter comparators associated with emissions stability may be dictated by a decision (e.g., a Boolean decision) determining or otherwise inferring if any of the tuning issues are lean blowout related (element 130), and these tuning issues include one or more of Low NOx, High CO, or High Class0 Dynamics, for example. If any of the tuning issues are lean blowout related, the criteria to meet stability (element 140) may be less stringent in certain examples; otherwise these stability parameters/comparators may be normal/longer in time (element 150). In additional or alternative examples, a check is performed to confirm whether the gas turbine's operating parameters are stable (element 160), such as based on a set of tuning constants, which can be overridden if transient tuning is allowed (element 170). Once an operational parameter is outside of its acceptable limit for a prescribed amount of time (element 180), and if all associated stability criteria (e.g., as described above and/or other such criteria per element 100) are satisfied or individually overridden by other criteria, the autotuner may make an adjustment to an operational control parameter (element 190), for example.

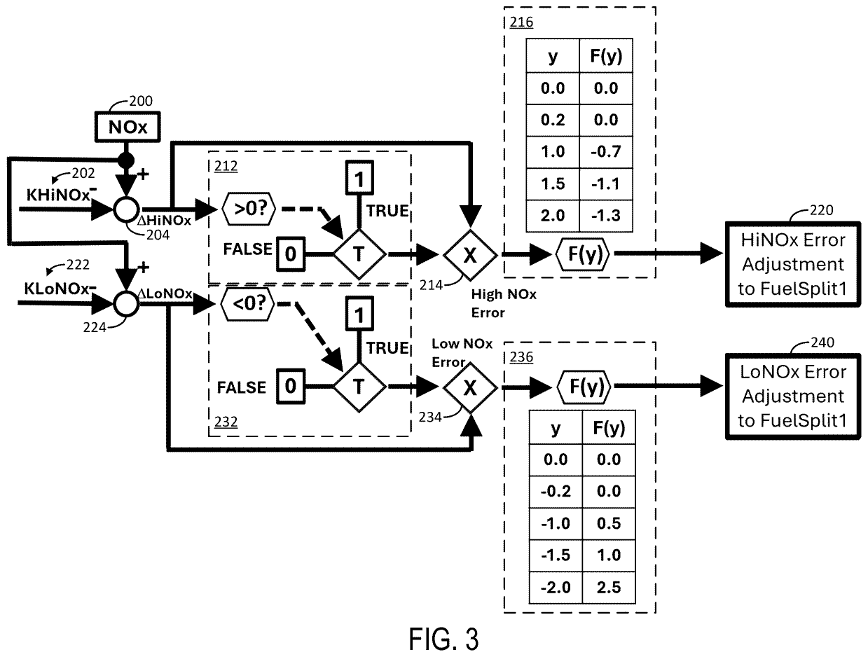

FIG. 3 shows a functional flow chart for the determination of the High NOx and Low NOx Error Adjustments to the operational control element FuelSplit1 in an autotuner, such as the autotuner 10 of FIG. 1, of the present disclosure. As shown, the operational parameter Turbine NOx 200 is compared to both a High NOx Limit 202 and a Low NOx Limit 222 to determine the intermediate calculations, ΔHiNOx 204 and ΔLoNOx 224, respectively. These intermediate calculations are gated through Transfer Blocks 212, 232 to determine or otherwise infer High NOx Error 214 and Low NOx Error 234, respectively. These errors are fed into Function Blocks 216, 236 to determine or otherwise infer a HiNOx Error Adjustment 220 and LoNOx Error Adjustment 240, respectively, to the operational control element FuelSplit1.

It is noted that the function blocks (e.g., 216, 236) that translate High and Low NOx Errors 214, 234 into FuelSplit1 Adjustments 220, 240 can independently be linear or non-linear (e.g., an algebraic polynomial function, such as a first-order polynomial function, a second-order polynomial function, or a third-order polynomial function). As an example, the Function Block 216 may correspond to a first function F(y)=ay³+by²+cy+d, and the Function Block 236 may correspond to a second function F(y)=ey³+fy²+gy+h. As used herein, F(y) may be a generic identifier of a function and not necessarily indicative that the first and second functions are the same function. In at least one embodiment, the Error Adjustments 220, 240 are not fixed, nor are they preset-instead, the adjustments may vary in magnitude with the extent of Emissions Error.

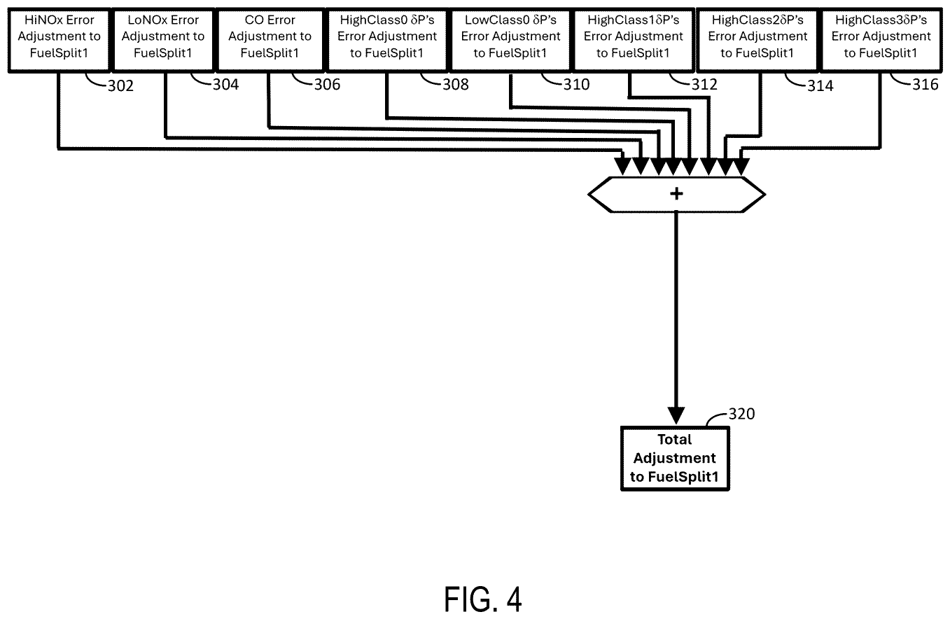

FIG. 3 illustrates embodiments of fuel split adjustments based on NOx emissions, and provides an example of the analogous approaches taken to calculate fuel split adjustments based on CO Emissions Error and Class0, 1, 2, and 3 Dynamics Error. All individual adjustments are summed or otherwise used to determine a total adjustment to the operational control element, in this case FuelSplit1 (as seen in FIG. 4).

FIG. 4 shows a functional flow chart for the determination of the Total Adjustment to the operational control element FuelSplit1 320 in an autotuner, such as the autotuner 10 of FIG. 1, according to the present disclosure. As shown, High and Low NOx Adjustments 302, 304 (see, e.g., FIG. 3) are summed together with Adjustments for High CO 306, High Class0 Dynamics 308, Low Class0 Dynamics 310, High Class1 Dynamics 312, High Class2 Dynamics 314, and High Class3 Dynamics 316 to determine the Total Adjustment to the operational control element FuelSplit1 320. It is contemplated that, in certain embodiments, the respective adjustments 302-316 to FuelSplit1 may not possess the same polarity nor the same magnitude of influence, and the total summation of all individual adjustments 302-316 may determine the Adjustment 320 to that operational control element. Element 310 indicates an adjustment for Low Class0 Dynamics, and similar such elements may adjust for Low Class1, Class2, and Class3 Dynamics as well in additional or alternative examples. An additional embodiment may include the removal of one or more of the Adjustments 302-316, such as Low Class0 Dynamics 310, from the summation calculation for the Total Adjustment to the Operational Control Element (FuelSplit1) 320.

In some embodiments, the flow charts of FIGS. 2-4, or portion(s) thereof, may be implemented as executable instructions stored in non-transitory memory of a computing device, such as a controller communicably coupled to the gas turbine engine (e.g., the autotuner 10 of FIG. 1). Moreover, in certain embodiments, additional or alternative sequences of commands, operations, function calls, etc. may be implemented as executable instructions on such a computing device, where individual commands, operations, function calls, etc. discussed with reference to FIGS. 2-4 may be added, removed, substituted, modified, or interchanged.

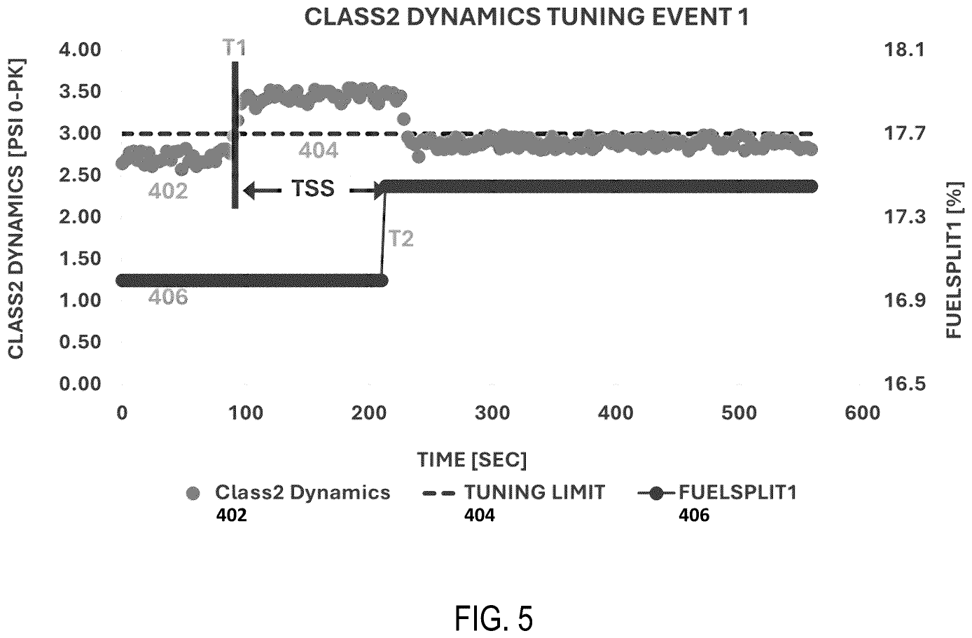

FIG. 5 shows an example of an autotuning system, such as the autotuner 10 of FIG. 1, manipulating an operational control element of a gas turbine as contemplated within the present disclosure. Line 402 is formed by a set of measurements representing the Class2 Combustor Dynamics response of the gas turbine engine relative to time. Line 404 represents the High Class2 Dynamics Tuning Limit, and Line 406 represents the Operational Control Element FuelSplit 1 relative to time. At time T1, the Class2 Combustor Dynamics 402 exceed the High Class2 Dynamics Tuning Limit 404. After sufficient time has elapsed (indicated by time element TSS) with this Tuning Issue above a threshold (e.g., the Class2 Combustor Dynamics 402), the autotuner makes an adjustment to the Operational Control Element FuelSplit1 406 at time T2. After a small time lag, the Class2 Combustor Dynamics 402 return to a level below the limit 404, and no more tuning moves are attempted by the autotuner in this example.

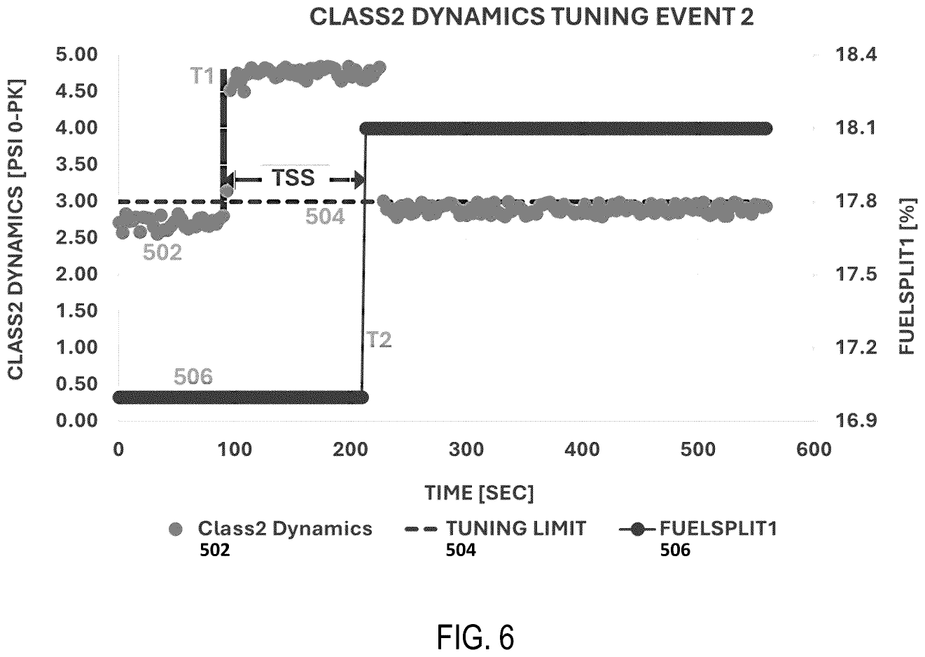

FIG. 6 shows another example of the autotuning system, such as the autotuner 10 of FIG. 1, manipulating an operational control element of the gas turbine as contemplated within the present disclosure. Line 502 is formed by a set of measurements representing the Class2 Combustor Dynamics response of the gas turbine engine relative to time. Line 504 represents the High Class2 Dynamics Tuning Limit, and Line 506 represents the Operational Control Element FuelSplit1 relative to time. At time T1, the Class2 Combustor Dynamics 502 exceed the High Class2 Dynamics Tuning Limit 504. After sufficient time has elapsed (indicated by time element TSS) with this Tuning Issue above a threshold (e.g., the Class2 Combustor Dynamics 502), the autotuner makes an adjustment to the Operational Control Element FuelSplit1 506 at time T2. It should be noted this movement is larger in magnitude than the previous example shown in FIG. 5, and is non-linearly proportional to the HighClass2 Dynamics Error (the difference between the Class2 Combustor Dynamics 502 and the High Class2 Dynamics Tuning Limit 504). After a small time lag, the Class2 Combustor Dynamics 502 return to a level below the limit 504, and no more tuning moves are attempted by the autotuner in this example.

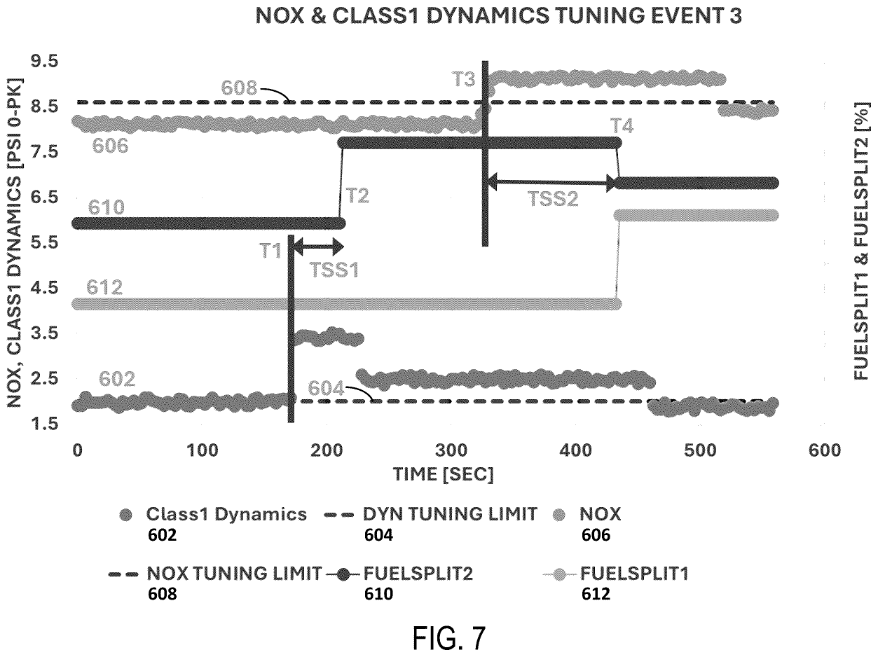

FIG. 7 shows another example of the autotuning system, such as the autotuner 10 of FIG. 1, manipulating an operational control element of the gas turbine as contemplated within the present disclosure. Line 602 is formed by a set of measurements representing the Class1 Combustor Dynamics response of the gas turbine engine relative to time. Line 606 is formed by a set of measurements representing the NOx emissions of the gas turbine engine relative to time. Line 604 represents the High Class1 Dynamics Tuning Limit, Line 608 represents the High NOx Tuning limit, Line 610 represents the Operational Control Element FuelSplit 2 relative to time, and Line 612 represents the Operational Control Element FuelSplit 1 relative to time. At time T1, the Class1 Combustor Dynamics 602 exceed the High Class1 Dynamics Tuning Limit 604. After sufficient time has elapsed (indicated by time element TSS1) with this Tuning Issue above a threshold (e.g., the Class1 Combustor Dynamics 602), the autotuner makes an adjustment to the Operational Control Element FuelSplit2 610 at time T2. This movement in FuelSplit2 610 results in a decrease in the Class1 Combustor Dynamics 602; however, the corresponding amplitude is still above the High Class1 Dynamics Tuning Limit 604, meaning tuning is still active. While waiting for further operational stability before a new tuning move (e.g., a second tuning event) can commence, the NOx emissions 606 go above the High NOx Tuning Limit 608 at time T3. Therefore, at time T3, a combination of tuning issues simultaneously exist-High NOx and High Class1 Dynamics. These two tuning issues facilitate opposite responses in FuelSplit2 610 (High NOx moves FuelSplit2 down; High Class1 Dynamics moves FuelSplit2 up)-the summation of these 2 tuning issues is a small adjustment down in FuelSplit2 610 at time T4 after stability is reached (as measured by time element TSS2).

It is noted that time element TSS2 is longer than time element TSS1, as more time was needed for the system to reach stability for the second event (neither tuning issue is lean blowout driven, so the tuning stability criteria have not changed for the length of the entire tuning example of FIG. 7). Additionally, another operational control parameter, FuelSplit1 612, was adjusted simultaneously with FuelSplit2 610 for the second tuning event-the combination of High NOx Error and High Class1 Dynamics Error facilitated a simultaneous modification in 2 operational control parameters, as exemplified. After a small time lag subsequent to the second tuning event, the Class1 Combustor Dynamics 602 and the NOx emissions 606 have both returned to levels below the respective limits 604, 608 and no more tuning moves are attempted by the autotuner in this example.

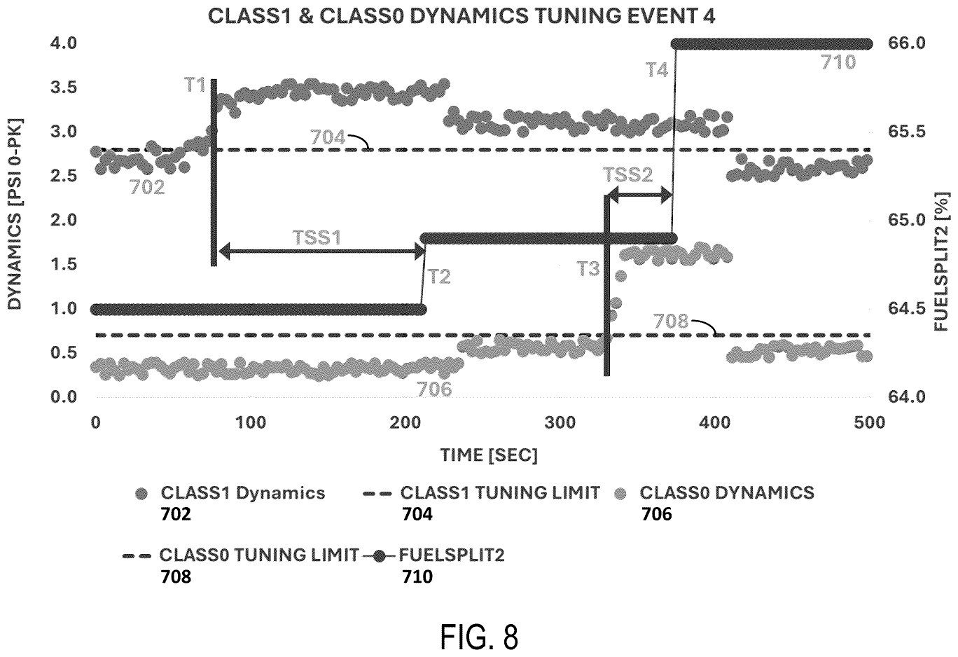

FIG. 8 shows another example of the autotuning system, such as the autotuner 10 of FIG. 1, manipulating an operational control element of the gas turbine as contemplated within the present disclosure. Line 702 is formed by a set of measurements representing the Class1 Combustor Dynamics response of the gas turbine engine relative to time. Line 706 is formed by a set of measurements representing the Class0 Combustor Dynamics response of the gas turbine engine over time. Line 704 represents the High Class1 Dynamics Tuning Limit, Line 708 represents the High Class 0 Dynamics Tuning Limit, and Line 710 represents the Operational Control Element FuelSplit2 relative to time. At time T1, the Class1 Combustor Dynamics 702 exceed the High Class1 Dynamics Tuning Limit 704. After sufficient time has elapsed (indicated by time element TSS1) with this Tuning Issue above a threshold (e.g., the Class1 Combustor Dynamics 702), the autotuner makes an adjustment to the Operational Control Element FuelSplit2 710 at time T2. This movement in FuelSplit2 710 results in a decrease in the Class1 Combustor Dynamics 702; however, the corresponding amplitude is still above the High Class1 Dynamics Tuning Limit 704, meaning tuning is still active. While waiting for further operational stability before a new tuning move (e.g., a second tuning event) can commence, the Class0 Combustor Dynamics 706 increase, eventually going above the High Class0 Dynamics Tuning Limit 708 at time T3. Therefore, at time T3, a combination of tuning issues simultaneously exist-High Class0 Dynamics and High Class1 Dynamics. The summation of these 2 tuning issues is a large adjustment up in FuelSplit2 710 (the polarity of the adjustment to operational control element FuelSplit2, with respect to elevated Class1 Dynamics and elevated Class0 Dynamics, is the same) at time T4 after stability is reached (as measured by time element TSS2).

It is noted that High Class0 Dynamics (error) facilitates a much larger FuelSplit2 Adjustment than High Class1 Dynamics, and as such the change to FuelSplit2 710 is much larger in magnitude for the autotuner's second adjustment (e.g., second tuning event) at time T4. High Class0 Dynamics are associated with Lean Blowout sensitivity, and as such the time lag between a tuning issue arising and the autotuner making an adjustment for the second (lean blowout-related) tuning issue (as indicated by time element TSS2) is less than the autotuner's first adjustment (as indicated by time element TSS1), as the criteria associated with stability are less stringent for a lean blowout concern. After a small time lag subsequent to the second tuning event, the Class1 Combustor Dynamics 702 and Class0 Combustor Dynamics 706 have both returned to levels below the respective limits 704, 708 and no more tuning moves are attempted by the autotuner in this example.

While embodiments described herein provide specific examples of more than one operational control element changing simultaneously, many more such scenarios exist. For example, FuelSplit1 and FuelSplit2 Adjustments can be implemented at the same time for tuning issues involving concurrent blowout risk and high NOx emissions, simultaneously elevated Class0 and Class2 Dynamics, or even for scenarios where elevated Class0 Dynamics are the only tuning issue of concern. Additionally, combustor fuel splits and turbine fuel-air ratio (via exhaust temperature reference or combustor bypass operation) can be adjusted simultaneously for blowout concerns, simultaneous elevated NOx and combustor dynamics tuning issues, etc.

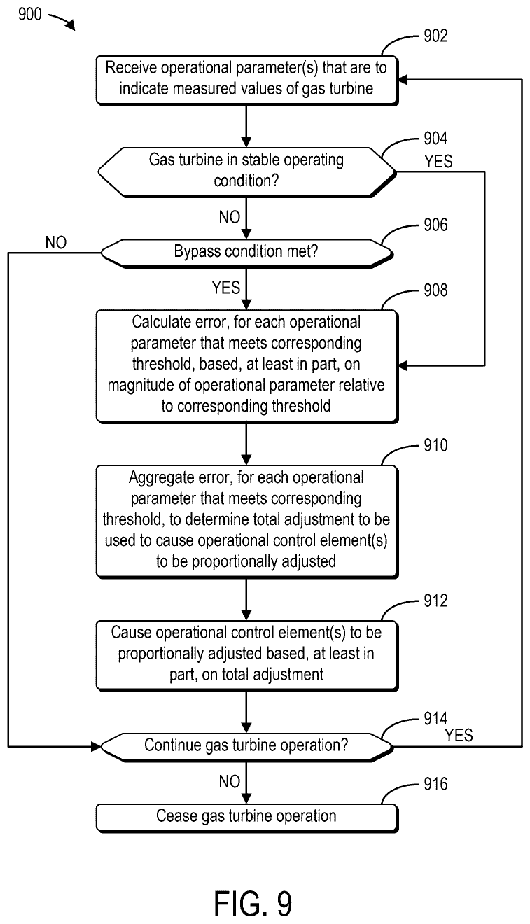

FIG. 9 shows an example embodiment of a flow chart for automatically adjusting operation of a gas turbine or other combustion system, such as according to a method 900. In some embodiments, systems and components described in detail above with reference to FIGS. 1-4 can perform part or all of the method 900 or be integrated into method 900. Accordingly, in some embodiments, a controller to be used to perform the method 900 as described in detail below may be the autotuner 10 of FIG. 1.

In some embodiments, the method 900, or portion(s) thereof, may be implemented as executable instructions stored in non-transitory memory of a computing device, such as a controller communicably coupled to the gas turbine engine (e.g., the autotuner 10 of FIG. 1). Moreover, in certain embodiments, additional or alternative sequences of commands, operations, function calls, etc. may be implemented as executable instructions on such a computing device, where individual commands, operations, function calls, etc. discussed with reference to the method 900 may be added, removed, substituted, modified, or interchanged.

At block 902, the method 900 may include receiving one or more operational parameters, or other inputs, that may indicate measured values of the gas turbine. In some embodiments, the measured values may be received from one or more sensors associated with the gas turbine, such as via one or more controllers (e.g., the turbine controller 20, the CEMS 30, the CDMS 40, and/or the DCS 50 of FIG. 1) that process the measured data (e.g., for use by the autotuner 10 of FIG. 1). In some embodiments, the measured values may be associated with exhaust emissions and/or combustor dynamics. Accordingly, in certain embodiments, the one or more operational parameters may correspond to one or more of combustor fuel flow distribution, turbine exhaust temperature, turbine exhaust emissions, or combustor dynamics. For example, the one or more operational parameters may include exhaust emissions levels, combustor dynamics, exhaust temperatures, compressor inlet and outlet temperatures and pressures, HRSG critical system parameters, and/or fuel system parameters. In additional or alternative embodiments, a user-defined parameter indicating transient tuning may be received (e.g., from an operator of the gas turbine).

At block 904, the method 900 may include inferring whether the gas turbine is in a stable operating condition. In some embodiments, one or more tuning constants or other control constants of the gas turbine may define or otherwise indicate criteria for the stable operating condition. As an example, at least a portion of the one or more tuning constants may be received from a turbine controller of the gas turbine (e.g., the turbine controller 20 of FIG. 1). As an additional or alternative example, at least a portion of the one or more tuning constants may be retrieved from non-transitory memory of an autotuner (e.g., the autotuner 10 of FIG. 1). If the gas turbine is inferred to be in the stable operating condition, the method 900 may proceed to block 908 to calculate error(s) of the one or more operational parameters (see below).

If the gas turbine is not inferred to be in the stable operating condition, the method 900 may proceed to block 906 to infer whether a bypass condition is met. In some embodiments, the bypass condition may be defined or otherwise indicated by one or more criteria according to which tuning of the gas turbine may proceed even if the gas turbine is not in a stable operating condition. As an example, the bypass condition being met may include the user-defined parameter indicating transient tuning being received (e.g., at the block 902). As an additional or alternative example, the bypass condition being met may include a threshold period of time between tuning events being met or otherwise fulfilled. As an additional or alternative example, the bypass condition being met may include an error (e.g., calculated at the block 908, such as during a previous tuning event) indicating lean blowout. If the bypass condition is not inferred to be met, the method 900 may proceed to block 914 to infer whether to continue operation of the gas turbine (see below).

If the gas turbine is inferred to be in the stable operating condition (e.g., at the block 904) or if the bypass condition is inferred to be met (e.g., at the block 906), the method 900 may proceed to the block 908 to calculate an error, for each given operational parameter of the one or more operational parameters that meets a corresponding threshold of one or more thresholds (e.g., one or more numerical values retrieved from non-transitory memory of the autotuner), based, at least in part, on a magnitude of the given operational parameter relative to the corresponding threshold. In some embodiments, the one or more thresholds may include one or more of a high NOx tuning limit, a low NOx tuning limit, a high CO tuning limit, a high class0 dynamics tuning limit, a high class1 dynamics tuning limit, a high class2 dynamics tuning limit, a high class3 dynamics tuning limit, a low class0 dynamics tuning limit, a low class1 dynamics tuning limit, a low class2 dynamics tuning limit, or a low class3 dynamics tuning limit. In an example embodiment, for a given operation parameter of the one or more operational parameters that meets a corresponding threshold of the one or more thresholds, the magnitude of the given operational parameter from the corresponding threshold may be an amount above a high level tuning limit or an amount below a low level tuning limit (in examples where the given operational parameter is associated with both of the high level tuning limit and the low level tuning limit, the high level tuning limit may be greater than the low level tuning limit). In some embodiments, the error for each of multiple operational parameters of the one or more operational parameters that meet multiple corresponding thresholds of the plurality of thresholds may be simultaneously calculated (e.g., in parallel).

In some embodiments, the error, if calculated for a given operational parameter of the one or more operational parameters, is indicative of a tuning issue or other concern for the given operational parameter. In an example embodiment, a magnitude of the error (e.g., an amount of deviation of the given operational parameter from a corresponding threshold) may scale with a relative importance of the tuning issue. Accordingly, in certain embodiments, the tuning issue may be resolved by proportional adjustment of one or more operational control elements (e.g., at block 912).

In some embodiments, the error may be calculated using a linear function. In other embodiments, the error may be calculated using a non-linear function. In an example embodiment, for each given operational parameter of the one or more operational parameters that meets a corresponding threshold of the one or more thresholds, a magnitude of the error may be calculated using an algebraic polynomial function based, at least in part, on a deviation of the given operational parameter from the corresponding threshold. For example, the algebraic polynomial function may be a first-order polynomial function, a second-order polynomial function, or a third-order polynomial function.

In embodiments wherein the calculated error indicates lean blowout, such that the bypass condition is met, the one or more tuning constants may be replaced with less stringent criteria to be used to infer whether the gas turbine is in the stable operating condition (e.g., at the block 904).

At block 910, the method 900 may include aggregating the error, for each given operational parameter of the one or more operational parameters that meets a corresponding threshold of the one or more thresholds, to determine a total adjustment to be used to cause one or more operational control elements to be proportionally adjusted (e.g., at block 912). In some embodiments, the error aggregation may be a summation of individual signed errors, resulting in an overall net adjustment (e.g., to be applied to the one or more operational control elements). In an example embodiment, the individual signed errors, or any other error values to be aggregated, may be outputs of the algebraic polynomial function (e.g., at the block 908).

At block 912, the method 900 may include causing the one or more operational control elements to be proportionally adjusted based, at least in part, on the total adjustment (e.g., determined at the block 910). In some embodiments, the one or more operational control elements may control one or more actuatable components of the gas turbine (e.g., engine component(s)). For example, the one or more operational control elements may include one or more of combustor fuel flow distribution reference, fuel gas inlet temperature, fuel gas inlet fuel composition, turbine exhaust temperature reference, or combustor bypass valve position. In some embodiments, multiple operational control elements may be simultaneously caused to be proportionally adjusted (e.g., in parallel).

In some embodiments, the one or more operational control elements, after being proportionally adjusted, may be provided to a turbine controller (e.g., the turbine controller 20 of FIG. 1), such that the turbine controller may be caused to control the one or more actuatable components, based, at least in part, on the one or more (proportionally adjusted) operational control elements, to operate a combustion engine of the gas turbine (e.g., the engine 60 of FIG. 1). In additional or alternative embodiments, an operational control element indicating the fuel gas inlet temperature, after being proportionally adjusted, may be provided to a fuel gas temperature controller, via a DCS (e.g., the DCS 50 of FIG. 1), such that the fuel gas temperature controller may be caused to control the fuel gas inlet temperature based, at least in part, on the (proportionally adjusted) operational control element. In additional or alternative embodiments, one or more operational control elements, after being proportionally adjusted based, at least in part, on error(s) in HRSG critical system parameters, may be provided to a HRSG, via the DCS, such that the HRSG may be caused to operate based, at least in part, on the one or more operational control elements.

At block 914, the method 900 may include inferring whether to continue operation (e.g., a current operational state) of the gas turbine. If operation of the gas turbine is inferred to continue, the method 900 may return to the block 902 to receive (updated) operational parameter(s) that are to indicate (additional) measured values of the gas turbine (e.g., to monitor for additional tuning events).

If operation of the gas turbine is not inferred to continue (e.g., if the autotuner receives a request to cease automated tuning of the gas turbine), the method 900 may proceed to block 916 to cease operation (e.g., a current operational state) of the gas turbine.

Embodiments of the present disclosure can be described in view of the following clauses:
1. A computer-implemented method for automatically adjusting operation of a gas turbine, the computer-implemented method comprising:
   receiving, at a tuning controller, one or more operational parameters that are to indicate measured values of the gas turbine, wherein the measured values are associated with exhaust emissions and/or combustor dynamics;
   inferring, by the tuning controller, whether the gas turbine is in a stable operating condition based, at least in part, on one or more tuning constants of the gas turbine; and
   responsive to either the gas turbine being inferred to be in the stable operating condition or a bypass condition being met, using the tuning controller to:
      calculate an error, for each operational parameter of the one or more operational parameters that meets a corresponding threshold of one or more thresholds, based, at least in part, on a magnitude of the operational parameter relative to the corresponding threshold; and
      proportionally adjust one or more operational control elements, that are to control one or more actuatable components of the gas turbine, based, at least in part, on the calculated error.
2. The computer-implemented method of clause 1, wherein the bypass condition being met comprises a user-defined parameter indicating transient tuning being received.
3. The computer-implemented method of any one of clauses 1 or 2, wherein the bypass condition being met comprises a threshold period of time between tuning events being met.
4. The computer-implemented method of any one of clauses 1-3, wherein the bypass condition being met comprises the calculated error indicating lean blowout.
5. The computer-implemented method of clause 4, further comprising, responsive to the calculated error indicating the lean blowout, replacing the one or more tuning constants with less stringent criteria to be used to infer whether the gas turbine is in the stable operating condition.
6. The computer-implemented method of any one of clauses 1-5, wherein:
   the one or more operational parameters are a plurality of operational parameters;
   the one or more thresholds are a plurality of thresholds; and
   the computer-implemented method further comprises:
      simultaneously calculating the error for each of multiple operational parameters of the plurality of operational parameters that meet multiple corresponding thresholds of the plurality of thresholds; and
      aggregating the error, for each of the multiple operational parameters, to determine a total adjustment to be used to cause the one or more operational control elements to be proportionally adjusted.
7. The computer-implemented method of any one of clauses 1-6, wherein:
   the one or more operational control elements comprise a plurality of operational control elements; and
   the computer-implemented method further comprises simultaneously causing the plurality of operational control elements to be proportionally adjusted based, at least in part, on the error.
8. The computer-implemented method of any one of clauses 1-7, wherein the error, if calculated for a first operational parameter of the one or more operational parameters, is indicative of a tuning issue for the first operational parameter.
9. The computer-implemented method of any one of clauses 1-8, wherein, for a first operational parameter of the one or more operational parameters that meets a corresponding first threshold of the one or more thresholds, the magnitude of the first operational parameter from the corresponding first threshold is an amount above a high level tuning limit or an amount below a low level tuning limit.
10. The computer-implemented method of clause 9, wherein the first operational parameter is associated with both of the high level tuning limit and the low level tuning limit, the high level tuning limit being greater than the low level tuning limit.
11. The computer-implemented method of any one of clauses 1-10, wherein the one or more thresholds comprise one or more of a high NOx tuning limit, a low NOx tuning limit, a high CO tuning limit, a high class0 dynamics tuning limit, a high class1 dynamics tuning limit, a high class2 dynamics tuning limit, a high class3 dynamics tuning limit, a low class0 dynamics tuning limit, a low class1 dynamics tuning limit, a low class2 dynamics tuning limit, or a low class3 dynamics tuning limit.
12. A gas turbine combustion system, comprising:
   a combustion engine comprising a plurality of actuatable components;
   one or more sensors that are to measure one or more operating conditions of the combustion engine; and
   a tuning controller including non-transitory memory and executable instructions, stored in the non-transitory memory, that, if executed by one or more processors of the tuning controller, cause the tuning controller to:
      receive, from the one or more sensors, a plurality of input parameters comprising exhaust emissions levels, combustor dynamics, exhaust temperatures, compressor inlet and outlet temperatures and pressures, heat recovery steam generator (HRSG) critical system parameters, and/or fuel system parameters;
      retrieve a plurality of thresholds to which the plurality of input parameters are to be respectively compared; and
      cause one or more operational control parameters, that are to control at least a portion of the plurality of actuatable components, to be proportionally adjusted based, at least in part, on an amount of deviation of an input parameter of the plurality of input parameters from a respective threshold of the plurality of thresholds, the one or more operational control parameters comprising one or more of combustor fuel flow distribution reference, fuel gas inlet temperature, fuel gas inlet fuel composition, turbine exhaust temperature reference, or combustor bypass valve position.
13. The gas turbine combustion system of clause 12, wherein the deviation of the input parameter of the plurality of input parameters beyond the respective threshold of the plurality of thresholds indicates a tuning issue that is to be resolved by the proportional adjustment of the one or more operational control parameters.
14. The gas turbine combustion system of any one of clauses 12 or 13, further comprising:
   a turbine controller communicatively coupled to the tuning controller, the turbine controller including second non-transitory memory and executable instructions, stored in the second non-transitory memory, that, if executed by one or more processors of the turbine controller, cause the turbine controller to:
      provide, to the tuning controller, one or more control constants associated with the one or more operational control parameters; and
      control the plurality of actuatable components, based, at least in part, on the one or more operational control parameters as proportionally adjusted by the tuning controller, to operate the combustion engine.
15. The gas turbine combustion system of any one of clauses 12-14, wherein: the one or more operational control parameters comprise the fuel gas inlet temperature; and
   the gas turbine combustion system further comprises:
      a distributed control system (DCS); and
      a fuel gas temperature controller communicatively coupled to the tuning controller via the DCS, including third non-transitory memory and executable instructions, stored in the third non-transitory memory, that, if executed by one or more processors of the fuel gas temperature controller, cause the fuel gas temperature controller to:
         control the fuel gas inlet temperature based, at least in part, on the one or more operational control parameters as proportionally adjusted by the tuning controller.
16. The gas turbine combustion system of any one of clauses 12-15, wherein:
   the plurality of input parameters comprise the HRSG critical system parameters; and
   the gas turbine combustion system further comprises:
      the distributed control system (DCS); and
      a HRSG communicatively coupled to the tuning controller via the DCS, the HRSG caused to operate based, at least in part, on the one or more operational control parameters as proportionally adjusted by the tuning controller.
17. A non-transitory computer-readable storage medium storing computer-executable instructions that, if executed by one or more processors of a computing system, are to cause the computing system to:
   receive, as input, measurements of one or more operational parameters of a combustion system from one or more sensors, the one or more operational parameters corresponding to one or more of combustor fuel flow distribution, turbine exhaust temperature, turbine exhaust emissions, or combustor dynamics; and
   proportionally adjust one or more operational control elements, that are to cause one or more engine components of the combustion system to be actuated, based, at least in part, on a magnitude of error of the measurements relative to a threshold value, the one or more operational control elements comprising one or more of combustor fuel flow distribution reference, fuel gas inlet temperature, fuel gas inlet fuel composition, turbine exhaust temperature reference, or combustor bypass valve position.
18. The non-transitory computer-readable storage medium of clause 17, wherein the magnitude of error scales with a relative importance of a tuning concern indicated by the measurements.
19. The non-transitory computer-readable storage medium of any one of clauses 17 or 18, wherein the computer-executable instructions, if executed by the one or more processors, are further to cause the computing system to:
   calculate, using an algebraic polynomial function, the magnitude of the error based, at least in part, on a deviation of the measurements from the threshold value.
20. The non-transitory computer-readable storage medium of clause 19, wherein the algebraic polynomial function is a first-order polynomial function, a second-order polynomial function, or a third-order polynomial function.

The specification and drawings are to be regarded in an illustrative rather than a restrictive sense. It will, however, be evident that various modifications and changes may be made thereunto without departing from the broader spirit and scope of the invention as set forth in the claims. That is, the described embodiments are susceptible to various modifications and alternative forms, and specific examples thereof have been shown by way of example in the drawings and are herein described in detail.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed but, on the contrary, the intention is to cover all modifications, alternative constructions, and equivalents falling within the spirit and scope of the invention, as defined in the appended claims. Additionally, elements of a given embodiment should not be construed to be applicable to only that example embodiment and therefore elements of one example embodiment can be applicable to other embodiments. Additionally, in some embodiments, elements that are specifically shown in some embodiments can be explicitly absent from further embodiments. Accordingly, the recitation of an element being present in one example should be construed to support some embodiments where such an element is explicitly absent.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate embodiments of the invention and does not pose a limitation on the scope of the invention unless otherwise claimed. No language in the specification should be construed as indicating any non-claimed element as essential to the practice of the invention.

Embodiments of this disclosure are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A computer-implemented method for automatically adjusting operation of a gas turbine, the computer-implemented method comprising:
receiving, at a tuning controller, one or more operational parameters that are to indicate measured values of the gas turbine, wherein the measured values are associated with exhaust emissions and/or combustor dynamics;
inferring, by the tuning controller, whether the gas turbine is in a stable operating condition based, at least in part, on one or more tuning constants of the gas turbine; and
responsive to either the gas turbine being inferred to be in the stable operating condition or a bypass condition being met, using the tuning controller to:
calculate an error, for each operational parameter of the one or more operational parameters that meets a corresponding threshold of one or more thresholds, based, at least in part, on a magnitude of the operational parameter relative to the corresponding threshold; and
proportionally adjust one or more operational control elements, that are to control one or more actuatable components of the gas turbine, based, at least in part, on the calculated error.

2. The computer-implemented method of claim 1, wherein the bypass condition being met comprises a user-defined parameter indicating transient tuning being received.

3. The computer-implemented method of claim 1, wherein the bypass condition being met comprises a threshold period of time between tuning events being met.

4. The computer-implemented method of claim 1, wherein the bypass condition being met comprises the calculated error indicating lean blowout.

5. The computer-implemented method of claim 4, further comprising, responsive to the calculated error indicating the lean blowout, replacing the one or more tuning constants with less stringent criteria to be used to infer whether the gas turbine is in the stable operating condition.

6. The computer-implemented method of claim 1, wherein:
the one or more operational parameters are a plurality of operational parameters;
the one or more thresholds are a plurality of thresholds; and
the computer-implemented method further comprises:
simultaneously calculating the error for each of multiple operational parameters of the plurality of operational parameters that meet multiple corresponding thresholds of the plurality of thresholds; and
aggregating the error, for each of the multiple operational parameters, to determine a total adjustment to be used to cause the one or more operational control elements to be proportionally adjusted.

7. The computer-implemented method of claim 1, wherein:
the one or more operational control elements comprise a plurality of operational control elements; and
the computer-implemented method further comprises simultaneously causing the plurality of operational control elements to be proportionally adjusted based, at least in part, on the error.

8. The computer-implemented method of claim 1, wherein the error, if calculated for a first operational parameter of the one or more operational parameters, is indicative of a tuning issue for the first operational parameter.

9. The computer-implemented method of claim 1, wherein, for a first operational parameter of the one or more operational parameters that meets a corresponding first threshold of the one or more thresholds, the magnitude of the first operational parameter from the corresponding first threshold is an amount above a high level tuning limit or an amount below a low level tuning limit.

10. The computer-implemented method of claim 9, wherein the first operational parameter is associated with both of the high level tuning limit and the low level tuning limit, the high level tuning limit being greater than the low level tuning limit.

11. The computer-implemented method of claim 1, wherein the one or more thresholds comprise one or more of a high NOx tuning limit, a low NOx tuning limit, a high CO tuning limit, a high class0 dynamics tuning limit, a high class1 dynamics tuning limit, a high class2 dynamics tuning limit, a high class3 dynamics tuning limit, a low class0 dynamics tuning limit, a low class1 dynamics tuning limit, a low class2 dynamics tuning limit, or a low class3 dynamics tuning limit.

12. A gas turbine combustion system, comprising:
a combustion engine comprising a plurality of actuatable components;
one or more sensors that are to measure one or more operating conditions of the combustion engine; and
a tuning controller including non-transitory memory and executable instructions, stored in the non-transitory memory, that, if executed by one or more processors of the tuning controller, cause the tuning controller to:
receive, from the one or more sensors, a plurality of input parameters comprising exhaust emissions levels, combustor dynamics, exhaust temperatures, compressor inlet and outlet temperatures and pressures, heat recovery steam generator (HRSG) critical system parameters, and/or fuel system parameters;
retrieve a plurality of thresholds to which the plurality of input parameters are to be respectively compared; and
cause one or more operational control parameters, that are to control at least a portion of the plurality of actuatable components, to be proportionally adjusted based, at least in part, on an amount of deviation of an input parameter of the plurality of input parameters from a respective threshold of the plurality of thresholds, the one or more operational control parameters comprising one or more of combustor fuel flow distribution reference, fuel gas inlet temperature, fuel gas inlet fuel composition, turbine exhaust temperature reference, or combustor bypass valve position.

13. The gas turbine combustion system of claim 12, wherein the deviation of the input parameter of the plurality of input parameters beyond the respective threshold of the plurality of thresholds indicates a tuning issue that is to be resolved by the proportional adjustment of the one or more operational control parameters.

14. The gas turbine combustion system of claim 12, further comprising:
a turbine controller communicatively coupled to the tuning controller, the turbine controller including second non-transitory memory and executable instructions, stored in the second non-transitory memory, that, if executed by one or more processors of the turbine controller, cause the turbine controller to:
provide, to the tuning controller, one or more control constants associated with the one or more operational control parameters; and
control the plurality of actuatable components, based, at least in part, on the one or more operational control parameters as proportionally adjusted by the tuning controller, to operate the combustion engine.

15. The gas turbine combustion system of claim 12, wherein:
the one or more operational control parameters comprise the fuel gas inlet temperature; and
the gas turbine combustion system further comprises:
a distributed control system (DCS); and
a fuel gas temperature controller communicatively coupled to the tuning controller via the DCS, including third non-transitory memory and executable instructions, stored in the third non-transitory memory, that, if executed by one or more processors of the fuel gas temperature controller, cause the fuel gas temperature controller to:
control the fuel gas inlet temperature based, at least in part, on the one or more operational control parameters as proportionally adjusted by the tuning controller.

16. The gas turbine combustion system of claim 12, wherein:
the plurality of input parameters comprise the HRSG critical system parameters; and
the gas turbine combustion system further comprises:
a distributed control system (DCS); and
a HRSG communicatively coupled to the tuning controller via the DCS, the HRSG caused to operate based, at least in part, on the one or more operational control parameters as proportionally adjusted by the tuning controller.

17. A non-transitory computer-readable storage medium storing computer-executable instructions that, if executed by one or more processors of a computing system, are to cause the computing system to:
receive, as input, measurements of one or more operational parameters of a combustion system from one or more sensors, the one or more operational parameters corresponding to one or more of combustor fuel flow distribution, turbine exhaust temperature, turbine exhaust emissions, or combustor dynamics; and
proportionally adjust one or more operational control elements, that are to cause one or more engine components of the combustion system to be actuated, based, at least in part, on a magnitude of error of the measurements relative to a threshold value, the one or more operational control elements comprising one or more of combustor fuel flow distribution reference, fuel gas inlet temperature, fuel gas inlet fuel composition, turbine exhaust temperature reference, or combustor bypass valve position.

18. The non-transitory computer-readable storage medium of claim 17, wherein the magnitude of error scales with a relative importance of a tuning concern indicated by the measurements.

19. The non-transitory computer-readable storage medium of claim 17, wherein the computer-executable instructions, if executed by the one or more processors, are further to cause the computing system to:
calculate, using an algebraic polynomial function, the magnitude of the error based, at least in part, on a deviation of the measurements from the threshold value.

20. The non-transitory computer-readable storage medium of claim 19, wherein the algebraic polynomial function is a first-order polynomial function, a second-order polynomial function, or a third-order polynomial function.
